(19) United States
(12) Patent Application Publication
(10) Pub. No.: US 2017/0290733 A1
(43) Pub. Date: Oct. 12, 2017

(54) MAGNETIC ELASTIC HAIRDRESSING MASSAGE COMB

(71) Applicant: Shen Zhen Rui Tian Technology Co., Ltd., Shenzhen (CN)

(72) Inventor: Shuhui Lin, Shenzhen, Guangdong (CN)

(21) Appl. No.: 15/481,461

(22) Filed: Apr. 7, 2017

(30) Foreign Application Priority Data
Apr. 11, 2016 (CN) 201610222029.3

(51) Int. Cl. A61H 11/00; A45D 2/00; A45D 1/04; A45D 1/18; A45D 24/16; A45D 20/48

(52) U.S. Cl. CPC A61H 11/00; A45D 24/16; A45D 20/48; A45D 1/04; A45D 1/18; A45D 2/002; A45D 2001/004

(57) ABSTRACT

Disclosed is a magnetic elastic hairdressing massage comb, which includes a circle of outer non-electric conductive adiabatic gears with a certain interval space arranged around a working face of the shell and a heat conductive comb body layer arranged at the inner of the non-electric conductive adiabatic gear circle, on which several lattice arrayed magnetic elastic moving gears are set. Said magnetic elastic moving gears are hollow heat conductive gears. A heat resistant magnetic body X is fixed in the bottom of the hollow heat conductive gear body. On the upside of X, a heat resistant magnetic body Y is arranged with X with like poles facing each other. The top of Y is connected to a small high-temperature resistant adiabatic column, which stretches out of the opening at the top of said hollow heat guide gears.

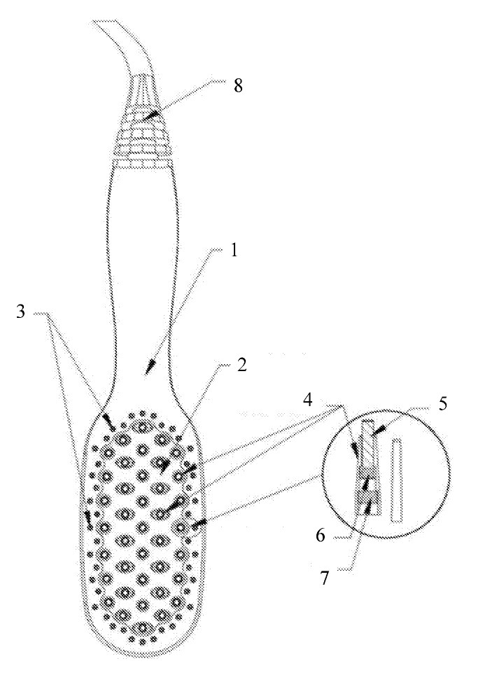

### CROSS-REFERENCE TO RELATED APPLICATIONS

The present invention claims the benefit of Chinese Patent Application No. 201610222029.3, filed on Apr. 11, 2016, which is hereby incorporated by reference as its entirety.

### FIELD OF THE INVENTION

The invention relates to hairdressing article used in daily life, specifically, hair treatment, hair-straightening and hair-curling.

### BACKGROUND OF THE INVENTION

Nowadays, people pay more and more attention on management of self-style and want to keep the hairstyle always new and changeable, thus it is urgent that a modeling tool can be operated at home and comparable to hair salon. The invention is developed to meet above requirements. In the market, straight hair comb basically uses heat conductive plate to clip hair to straight; and a hair curler makes hair-curling or produces hair style by heating rod on hair directly. Above methods damage hair quality, and hair-dressing person cannot operate by himself/herself. However, this product changes hairstyle in daily combing movement by revolutionary form of comb, and has the feature of easy operation, high efficiency, good experience, perfect performance, high safety, portability, and keep-fit massage effect.

### SUMMARY OF THE INVENTION

The invention aims to provide a magnetic elastic hairdressing massage comb, which utilizes the principle that the same poles repel, produces a separating space in the hollow space, the extension and shrink of the hollow separating space induces smooth elastic touching when it touches the scalp, thus improves custom experience in doing hairstyle. At the same time, it has magnetic massage effect, invigorates the circulation of scalp blood and promotes hair healthy growth.

The technical solution of the invention is, based on the existing hollow shell, electric heating device and an electric source wire, on the shell working face, a circle of outer non-electric conductive adiabatic gears with a certain interval space is set around the working face. A comb body heat conductive layer is arranged at the inner of the non-electric conductive adiabatic gear circle, on which several lattice arrayed magnetic elastic moving gears are set. The said magnetic elastic moving gear is hollow heat conductive. Said magnetic elastic moving hollow heat conductive gear, is heat resistant magnetic body X fixed in the bottom of a hollow heat guide gear body, another movable heat resistant magnetic body Y set on the upside of the magnetic body X with like poles facing each other, and a high temperature-resistant adiabatic column connected on the upside of the magnetic body Y, wherein the high temperature-resistant adiabatic column stretches out of the opening at the top of said hollow heat conductive gears, and the bottom side of the heat conductive comb body connects with the electric heating device and electric source wire in the shell.

Above said heat resistant magnetic body X and heat resistant magnetic body Y are set with like poles facing each other) and a separating space is retain between X and Y by the repulsion caused by repulsive interactions. The space extends and shrinks with force caused by combing movement, thus touching is smoothly and elastic in use. When external force presses on high-temperature resist adiabatic column, the pressure conducts to the heat resistant magnetic body Y and reduces the separate space between X and Y. The small high-temperature resist adiabatic column shrinks to a lowest height and keeps higher than the opening at the top of said hollow heat guide gear to guard the heat resist and anti-scald to skin.

The height of the outer adiabatic gear said in the invention is higher than the height of hollow heat conductive gear, and lower than the top end of small compressed high temperature resist adiabatic column. Hollow heat conductive comb body said above is made of metal with light-weight and small thermal conductivity, and a layer of extra fine or nanometer ceramic coating on metal surface is sprayed.

Non-electric conductive adiabatic outer gears are made of plastic with high temperature-resistant, non-electric conductive and impact-resistant.

Operational principle of the invention is, the temperature of heat conductive body is about 180° C. when it is in use. Instantaneous temperature at start can reach 25° C., which can scald skin, thus, a circle of non-electric conductive heat separating outer gears is set to make full protect. Because the non-electric conductive heat separating outer gear is higher than the opening at the top of the hollow heat conductive gear, no matter what direction you comb hair in, the outer heat separating comb gear and the small high-temperature resist adiabatic column can protect you fully. Twisted in the arranged group of heat conductive gears, hair is heated evenly and easy to be straightened or curled. Because there are magnets in hollow heat conductive comb gears, the comb has magnetic massage effect and invigorates the circulation of scalp blood, promotes scalp and hair healthy growth. As the two magnetic bodies are set with same poles and produced repulsion, the separating space between the magnet bodies extends and shrinks with force, creating a smooth and elastic touching when comb gears touch scalp, thus further improves the custom experience in hair style intensively.

### BRIEF DESCRIPTION OF THE DRAWINGS

The figure is the structure schematic diagram of the invention.

### DETAILED DESCRIPTION OF ILLUSTRATED EMBODIMENTS

For understanding the objective, the technical content and the advantages of the present invention more sufficiently, some embodiments of the present invention will be described as follows, by way of example only, with reference to the accompanying drawings. The embodiments disclosed below are not intended to be exhaustive or to limit the invention to the precise forms disclosed in the following detailed description.

Referring to the figure, based on hollow shell 1, electric heating device and electric wire 8, the invention sets a circle of outer non-electric conductive adiabatic gears 3 with a certain interval space around the shell working face. A heat conductive layered comb body 2 is arranged at the inner of the non-electric conductive adiabatic gear circle 3. Lattice arrayed hollow heat conductive gears 4 are set on the heat conductive comb body 2. The bottom of said hollow heat conductive gears 4 is fixed with a heat resistant magnetic body X7, and another movable heat resistant magnetic body Y6 is set on the upside of the magnetic body X7 by face to face with same polar. A small high temperature-resistant adiabatic column 5 connects with the upside of magnetic body Y6. The upper side of the small high temperature-resistant adiabatic column 5 stretches out of the opening at the top of said hollow heat conductive gears. The bottom of the hollow heat conductive gears 4 connects with electric heating device and electric source wire 8 in the underside of the comb body 2. Heat resistant magnetic body X7 and heat resistant magnetic body Y6 retain a separating space because of the repulsion caused by repulsive interactions. when the external force is applied on the small high-temperature resist adiabatic column, the pressure conducts to heat resistant magnetic body Y6 and reduce the separate space between X7 and Y6, the small high-temperature resistant adiabatic column shrinks to a lowest height but keep higher than the top of said hollow heat conductive gears to guard the heat resist and anti-scald to skin. The height of the outer non-electric conductive adiabatic gears 3 is higher than the top of the hollow heat conductive gears, and lower than the top of small compressed high temperature-resistant adiabatic column 5. Said hollow heat conductive gears 4 and connected heat conductive comb body 2 are made of metal with light weight and high thermal conductivity, then a layer of extra fine or nanometer ceramic coating is sprayed on metal surface. Outer non-electric conductive adiabatic gears are made of plastic with high temperature-resistant, non-electric conduction and high hardness.

Hollow shell 1 in the invention is made of high temperature-resistant non-electric conductive impact-resistant plastic. Small high temperature-resistant adiabatic column 5 is made of plastic with high temperature-resistant, non-electric conduction and high hardness. Heat resistant magnetic body 6 and 7 are made of magnet with high temperature-resistant, rare-earth materials, stability and difficult demagnetization. Heating device and an electric source wire 8 are made of materials with high safety, meeting heating temperature requirements (all kinds of heating), stability and durability.

Above descriptions of embodiments are provided for further illustrating the technical content of the present invention, so as to facilitate understanding and it should be understood that the invention is not to be limited to the disclosed embodiments. Any technique extension and recreation according to the present invention should be included within the scope of protection of the invention.

What is claimed is:

1. A magnetic elastic hairdressing massage comb, comprising a hollow shell, an electric heating device and an electric source wire, wherein a circle of non-electric conductive adiabatic outer gears with a certain interval space are set around a working face of the shell, a comb body heat conductive layer is arranged at the inner of the non-electric conductive adiabatic gear circle, on which several lattice arrayed magnetic elastic moving gears are set, the said magnetic elastic moving gears are hollow heat conductive gears, each of the said magnetic elastic moving hollow heat conductive gears comprises a hollow heat conductive gear body, a heat resistant magnetic body X fixed in the bottom of the hollow heat conductive gear body, a movable heat resistant magnet body Y is set on the upside of magnetic body X by face to face with the same pole, and a high temperature-resistant adiabatic column connected on the upside of the magnetic body Y, the high temperature-resistant adiabatic column stretches out of an opening of the top of said hollow heat conductive gears; and the bottom side of heat conductive comb body connects with an electric heating device and an electric source wire both of which is arranged in the shell.

2. The magnetic elastic hairdressing massage comb of claim 1, wherein the heat resistant magnetic body X and the heat resistant magnetic body Y are set with like poles facing each other and a separating space is retained between the heat resistant magnetic body X and the heat resistant magnetic body Y by the repulsion caused by repulsive interactions; the space extends and shortens with force caused by combing movement, thus touching is smoothly and elastic in use; when the external force is applied on the small high-temperature resist adiabatic column, the pressure conducts to the heat resistant magnetic body Y and furtherly reduces the separate space between the heat resistant magnetic body X and the heat resistant magnetic body Y, the high-temperature resistant adiabatic column shrinks to a lowest height but keep higher than the top of said hollow heat conductive gears to guard the heat resist and anti-scald to skin.

3. The magnetic elastic hairdressing massage comb of claim 1, wherein the hollow shell is made of high temperature-resistant, non-electric conductive and impact-resistant plastic.

4. The magnetic elastic hairdressing massage comb of claim 1, wherein the heat conductive comb body is made of metal with light weight and high thermal conductivity, and a layer of extra fine or nanometer ceramic coating is sprayed on metal surface.

5. The magnetic elastic hairdressing massage comb of claim 1, wherein the height of the non-electric conductive adiabatic gear is higher than the height of hollow heat guide gear, and lower than the top end of compressed small high temperature resist adiabatic column.

6. The magnetic elastic hairdressing massage comb of claim 1, wherein the non-electric conductive adiabatic outer gears are made of plastic with non-electric conduction, heat resistance and high rigidity.

7. The magnetic elastic hairdressing massage comb of claim 1, wherein the small high temperature-resistant adiabatic column is made of plastic with high temperature-resistant, non-electric conduction and high hardness.
